(19) United States
(12) Patent Application Publication
(10) Pub. No.: US 2006/0042437 A1
(43) Pub. Date: Mar. 2, 2006

(54) Machining apparatus and methods

(76) Inventor: Christopher Paul Gerrard, Dorset (GB)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/516,378

(22) PCT Filed: May 27, 2003
(86) PCT No.: PCT/GB03/02303

§ 371 Date: Jul. 13, 2005

(30) Foreign Application Priority Data
May 31, 2002 (GB) 0212775.1

(51) Int. Cl. B26D 3/00

(52) U.S. Cl. 83/39; 125/13.01; 409/231

(57) ABSTRACT

A machining spindle comprising an inner shaft (110a) arranged for carrying a first tool (5a) for machining a work-piece and an outer shaft (110b) arranged for carrying a second tool (5b) for machining the workpiece, wherein the shafts are mounted one inside the other for rotation about a common axis and for axial movement relative to each other. The shafts are supported by air bearings. The spindle is particularly suited to dicing silicon wafers into oblong chips.

This invention relates to machining apparatus and methods and particularly to apparatus and methods for use in grinding and/or cutting workpieces, for example semiconductor wafers.

There are a large number of different circumstances where it is necessary to machine workpieces. The apparatus and methods described in the present application are applicable for use in a broad range of such circumstances. However, the apparatus and methods of the present application are particularly useful in dicing workpieces such as semiconductor wafers and arrays of chip scale packages for supporting completed chips. Some of the introduction and specific description in this specification will be directed to such dicing apparatus and methods. It, of course, should be borne in mind that the apparatus and methods in general and the described construction of the machining spindle are also appropriate for use in a large number of other machining operations.

In the production of semiconductor chips it is commonplace to start with a semiconductor wafer which is then appropriately processed to provide the necessary circuits for a plurality of chips arranged in an array on the wafer. So called “streets” are left between the circuits for each chip. These streets contain no circuitry and are arranged such that there is a first set of parallel streets running in a first direction and a second set of parallel streets running perpendicularly to the first set. These streets provide a region which can be cut to allow the wafer to be cut up or “diced” into the individual chips.

The resulting chips are often mounted in chip scale package elements so that they can be more easily handled and inserted into the appropriate circuit boards for their intended use. Chip scale package elements are also often made by dicing a sheet containing an array of package elements. The methods and apparatus of the present application may also be used in dicing such sheets of chip scale package elements. Moreover, in at least some circumstances, one machine may be used for the two dicing operations.

When dicing wafers it is often the case that the chips have an oblong shape rather than a square shape. This, of course, means that the streets running in one direction are spaced by a different distance than the streets running in the other direction. Any machine used to dice the wafer must be able to cope with this difference in spacing.

In the simplest dicing machines a single cutting tool is used and this travels back and forth across the wafer cutting one street at a time in a first direction. Once all of the streets in a first direction have been cut the workpiece is typically rotated through 90° so that the cutting tool can be used to cut all of the streets in the second direction.

However, in an effort to improve efficiency, systems have been devised where a plurality of cutting tools are used such that the wafer may be cut along a plurality of streets simultaneously.

In existing systems where a plurality of streets can be cut simultaneously there is typically at least one of the following two problems.

In a first set of existing systems a multiple cutting head is provided which is driven by one shaft. In such systems the spacing between each cutting tool cannot be altered without replacing the cutting head as a whole. This renders impractical, or at least significantly slows down, an operation where a wafer needs to be diced into oblong shapes.

In a second set of existing systems two or more separate cutting tools are provided each of which is separately driven by its own shaft and motor etc. Such a system can be made to cope with dicing oblong chips but there is a disadvantage in that two complete sets of supporting and driving apparatus are required and there can be difficulties in maintaining accuracy between the two cutting tools.

It is an object of the present invention to provide machining apparatus and methods which alleviate at least some of the problems associated with the prior art.

According to one aspect of the present invention there is provided a machining spindle comprising a first shaft arranged for carrying a first tool for machining a workpiece and a second shaft arranged for carrying a second tool for machining the workpiece, wherein the shafts are mounted for rotation about a common axis and for axial movement relative to each other.

This arrangement allows the tools to be operated accurately relative to one another whilst avoiding the need for the use of two separate spindles and their associated equipment.

Preferably the shafts run one inside the other so that the first shaft is an inner shaft and the second shaft is an outer shaft.

The spindle may comprise a main body within which the shafts are journalled. In currently preferred embodiments the inner shaft is mounted within the outer shaft which in turn is journalled within the main body. The inner shaft may be journalled within the outer shaft to allow relative rotation between the two shafts.

Preferably a bearing is provided to allow relative movement between the inner and outer shafts. Typically this bearing is arranged to allow relative axial movement. This bearing may also be arranged to allow relative rotation between the inner and outer shafts. The arrangement of the spindle as a whole is typically such that one of the shafts may be arranged to move axially relative to the main body.

Air bearings may be provided to support the shafts. The main body may comprise jets to provide air to a bearing allowing relative rotation between the main body and the outer shaft. The inner shaft may comprise jets to provide air to the bearing allowing relative movement between the inner and outer shafts.

The air bearings may be arranged such that air is purged from the spindle at positive pressure (relative to the ambient pressure) at all locations which may be exposed to the by-products of machining operations. This can help to ensure that dust, swarf etc does not enter the bearings.

In an alternative to this or in addition to this, supplementary sealing means may be provided. Such a seal may be a labyrinthine seal.

“Air bearings” per se, where a gas provides support and lubrication, are well known. Whilst the gas will normally be air, as is conventional, the expression “air bearing” in this specification also covers bearings using or designed to use other gases in place of, or in addition to air.

The spindle may comprise at least one electric motor for rotatingly driving the shafts.

In one set of embodiments the spindle is arranged to allow the first shaft to rotate at a different speed from and/or in a opposite direction from the second shaft. The spindle may comprise two electric motors, a respective one of the motors for rotatingly driving each shaft.

In another set of embodiments the spindle is arranged so that the first and second shafts rotate in synchrony with one another. In such embodiments drive transfer means may be provided for transferring drive from one shaft to the other. The drive transfer means may comprise a pin mounted on one of the shafts and disposed in a recess in the other of the shafts such that shafts may move axially relative to one another without interrupting the transfer of drive.

The spindle may comprise axial drive means for axially driving the shafts relative to one another. The axial drive means may be arranged to act on one of the shafts via an axial bearing assembly. The axial bearing assembly may be arranged for axial movement within an air bearing provided in the main body. A portion at an end of one of the shafts may be captured in the axial bearing assembly.

Encoding scale means may be provided to indicate the axial position of the shaft which is moveable axially relative to the main body. The encoding scale means may, for example, be provided on the axial bearing assembly or the axial drive means.

The machining spindle may be a cutting and/or grinding spindle arranged for supporting cutting and/or grinding tools.

The machining spindle may be a dicing spindle, the shafts each being arranged for supporting a respective cutting wheel. The workpiece in such a case may, for example, be a semiconductor wafer or a sheet comprising an array of chip scale package elements.

Where two cutting wheels are used they may be different from one another in diameter and/or other properties. The cutting wheels may be used in a two stage cutting process. One of the cutting wheels may be a V-cutter for use in making a first cut.

The grinding tools may be cup grinders for grinding a surface by axially moving the tool into contact with the workpiece. The grinding tools may be radial grinders. The radial grinders may be arranged for use in form grinding a complex shape. The grinding tools may be arranged so that the first tool can grind the internal surface of a bore whereas the second tool can grind the external surface of the component having the bore.

According to another aspect of the invention there is provided a machining apparatus comprising a machining spindle as defined in any of the aspects above and a support arrangement for supporting the spindle.

The machining apparatus may further comprise a workpiece table arranged for supporting a workpiece during machining.

The apparatus may further comprise a first tool mounted on the first shaft and a second tool mounted on the second shaft. The first and second tools may, for example, be cutting wheels, grinding tools etc as explained above.

According to a further aspect of the invention there is provided a method of machining a workpiece comprising the step of using a machining spindle or a machining apparatus as defined in any one of the aspects above.

In one particular application of a machining spindle or apparatus, the ability to move one shaft axially relative to the other may be used to compensate for thermal growth, or more particularly differences of thermal growth, in the shaft or other components as they heat up due to operation. In such a method the spacing between the carried tools, for example cutting wheels, may be monitored and the shafts moved relative to one another in an attempt to keep the spacing constant.

The present invention will now be described by way of example only with reference to the accompanying drawings in which:—

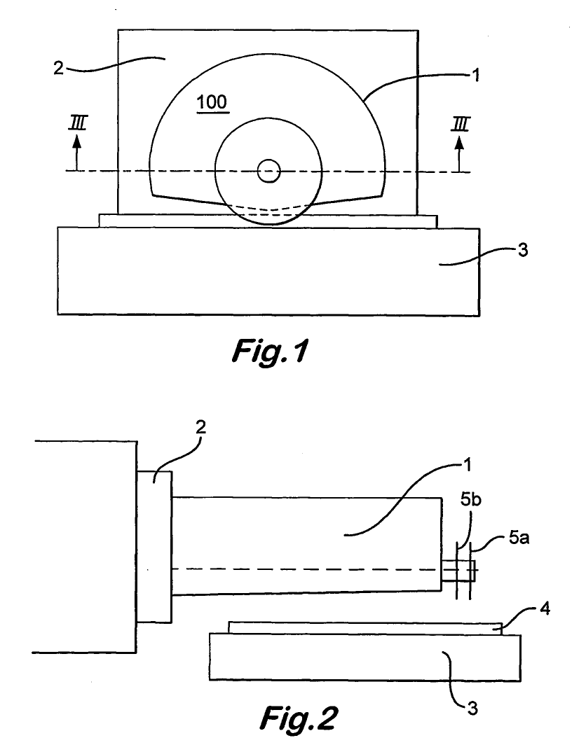

FIG. 1 is a schematic end view of a machining apparatus;

FIG. 2 is a side view of the machining apparatus of FIG. 1;

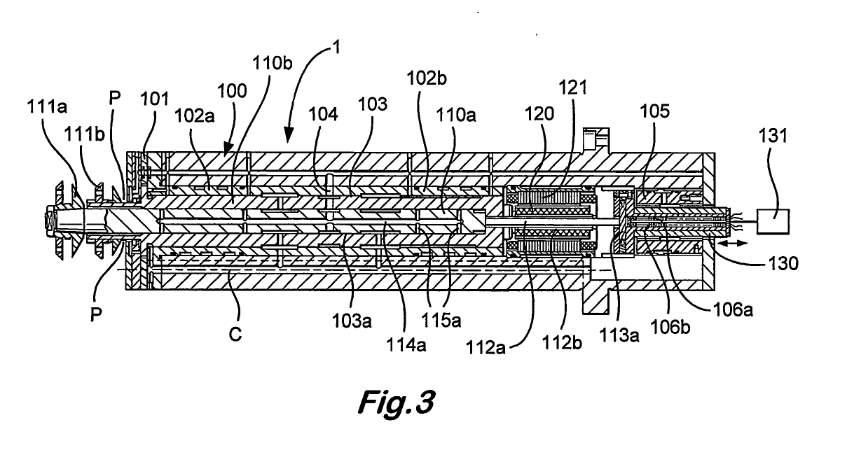

FIG. 3 is a sectional view on line III-III of the machining spindle of the apparatus shown in FIG. 1;

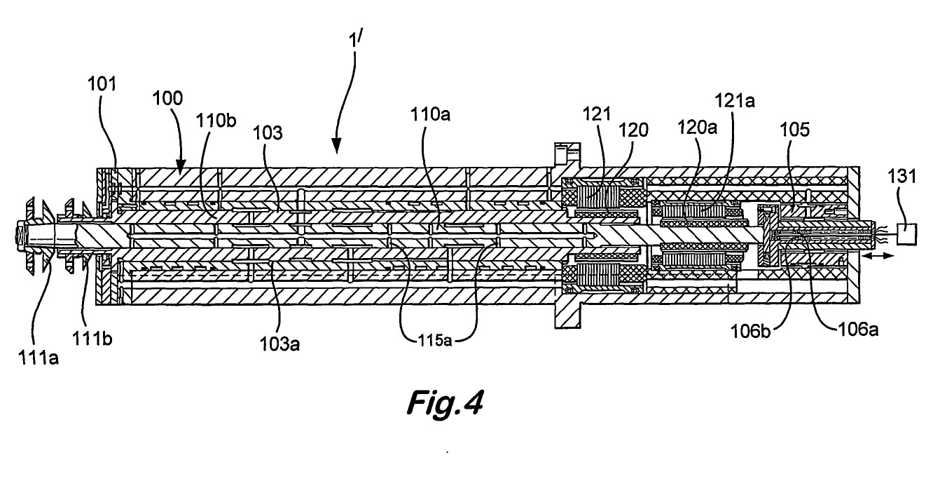

FIG. 4 shows an alternative machining spindle which may be used in the machining apparatus shown in FIG. 1;

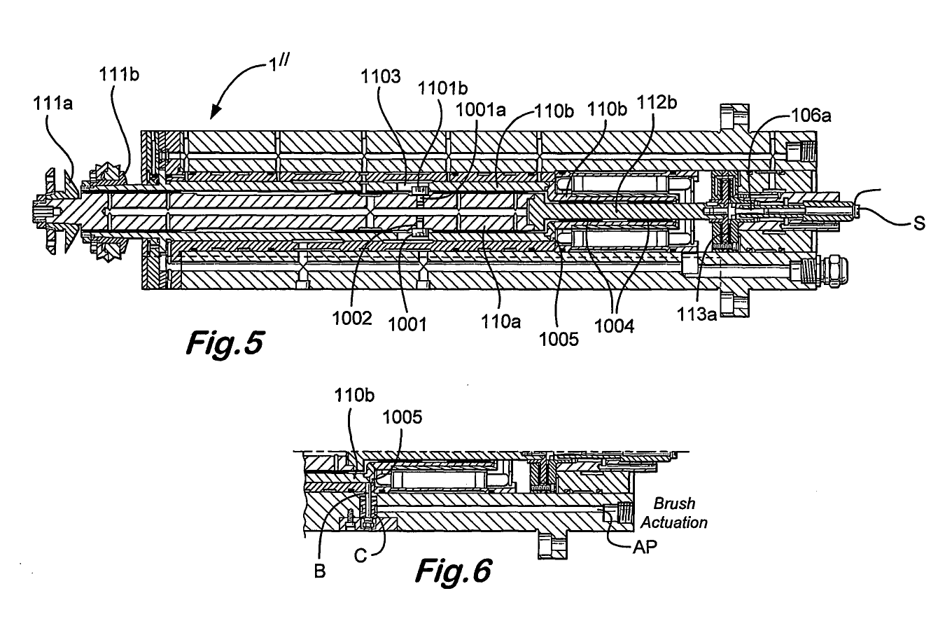

FIG. 5 shows an alternative machining spindle which may be used in the machining apparatus shown in FIG. 1; and

FIG. 6 shows part of the alternative machining shown in FIG. 5.

FIGS. 1 and 2 show a machining apparatus comprising a machining spindle 1 supported by a spindle support carriage 2 which is arranged for supporting the machining spindle 1 and allowing translational movement of the spindle in three perpendicular directions one of which is parallel to the axis of the spindle 1. The apparatus also includes a workpiece table 3 upon which a workpiece 4 may be supported for machining. The workpiece table 3 is arranged so as to be rotatable about an axis perpendicular to the surface on which the workpiece is supported, i.e. an axis in the plane of the page as shown in FIGS. 1 and 2. The machining spindle 1 carries a pair of cutting wheels 5a, 5b which are spaced from one another in a direction parallel to the axis of the spindle 1.

In operation, these cutting wheels 5a, 5b may be brought into contact with the workpiece 4 by moving the machining spindle 1 on its carriage 2 in the appropriate direction (the vertical direction in FIGS. 1 and 2). The cutting wheels 5, 5b may then be drawn across the workpiece 4 in order to create cut or score lines across the workpiece 4 in a first direction. This process may be repeated as many times as is desired across the workpiece 4 so as to cut the workpiece into strips. The workpiece table 3 may then be rotated about the axis defined above such that its orientation is changed by 90°. This rotation will of course occur with the cutting wheels 5a, 5b out of contact with the workpiece 4. Once the workpiece table 3 and workpiece 4 have been rotated the workpiece 4 can be cut in a perpendicular direction to the first cuts, again using the cutting wheels 5a, 5b. It will be appreciated that this process serves to dice the workpiece 4.

In one particular application, the workpiece 4 may be a semiconductor wafer and the cutting wheels 5a, 5b may be used to cut along the streets in the wafer so as to dice the wafer into the appropriate chips.

As will be explained in more detail below, the spacing between the spaced cutting wheels 5a, 5b may be changed by virtue of the construction of the machining spindle 1. The ability to change the spacing between the cutting wheels 5a, 5b may be used in a number of different ways. Perhaps most typically this ability to change the spacing between the cutting wheels 5a, 5b can be used to dice a workpiece into oblong elements, for example, oblong chips. In such a case the cutting wheels 5a, 5b will be used to cut the workpiece in a first direction whilst they are spaced with a first spacing and then the spacing between the cutting wheels 5a, 5b will be changed before cutting in the second direction so that the second set of cuts have a different spacing.

It should be noted that there is no need for the cutting wheels 5a, 5b to cut adjacent streets or other cut lines in a single traverse of the workpiece 4. Especially in the case of semiconductor dicing it may be more common that, say, the first and third or the first and fourth streets are cut with a first pass and then the second and fourth or second and fifth are cut with a second pass and so on. The reason for choosing such a cutting technique is simply that there will be a physical limit on how small the spacing can be made between the cutting wheels 5a, 5b.

FIG. 3 shows the machining spindle 1 of the apparatus shown in FIGS. 1 and 2. Firstly it should be noted that as shown in FIG. 1, the main body 100 of the machining spindle has a non-circular shape. In particular, there are cutaways from the circular shape at the region of the spindle 1 where it comes closest to the workpiece table 3. This configuration is to allow the spindle 1 to pass over the top of a supported workpiece 4 without unnecessarily increasing the diameter of the cutting wheels 5a, 5b or otherwise compromising the performance of the apparatus. It will be noted that the section of the spindle 1 shown in FIG. 3 is taken along a line where the spindle 1 has its full diameter. The minimum radial dimension of the spindle 1, due to the cutouts, is indicated by the dotted line C shown in FIG. 3.

The main body 100 of the spindle 1 houses an inner shaft 110a, at the distal end of which is provided a hub 111a for carrying the first cutting wheel 5a (not shown in FIG. 3). This inner shaft 110a is journalled for rotation about the central axis of the machining spindle 1 inside an outer shaft 110b. The outer shaft 110b carries a hub 111b at its distal end for supporting the second cutting wheel 5b (not shown in FIG. 3). The outer shaft 110b is journalled for rotation about the central axis of the machining spindle 1 inside the main body 100. Thus, the outer shaft 110b is generally a hollow cylinder within which the inner shaft 110a is disposed.

The inner shaft 110a has an extension portion 112a which extends through the proximal end of the outer shaft 110b. The rotor 120 of an electric motor for driving the shafts 110a, 110b is mounted on a collar 112b of the outer shaft 110b which surrounds this extension portion 112a. The stator of the electric motor 121 is mounted in the main body 100.

The extension portion 112a of the inner shaft 110a terminates in a disc like portion 113a which is captured in a moving axial bearing assembly 130.

Whilst the disc like portion 113a is captured in the moving axial bearing assembly 130, air bearings exist around the disc like portion 113a such that rotation of the disc portion 113a and hence the inner shaft 110a as a whole is not prevented or substantially hindered.

On the other hand, the moving axial bearing assembly 130 is arranged for axial movement within the main body 100 and as this axial movement occurs, a corresponding axial movement of the inner shaft 110a is caused to occur due to the disc like portion 113a being captured in the moving axial bearing assembly 130.

An axial driving means 131 is provided for driving the axial bearing assembly 130 in the axial direction. The axial driving means 131 is arranged to be able to drive the axial bearing assembly, and hence the inner shaft 110a in both directions along the axis of the spindle 1.

In contrast, the outer shaft 110b is held against axial movement relative to the main body 100 by an axial bearing plate 101 provided at the distal end of the main body 100. Thus, by operating the axial driving means 131 to move the axial bearing assembly 130 and hence the inner shaft 110a, the spacing between the hubs 111a and 111b and hence the cutting wheels 5a and 5b can be altered.

The above description covers the main features which are directed at the principle of operation of the machining spindle 1. FIG. 3 shows more detail of one practical implementation of such a system and some of these details as well as others will be described below.

The electric motor comprising the rotor 120 and stator 121 can be used to rotatingly drive the outer shaft 110b and furthermore control means (not shown) can be used to sense and control the speed of rotation. This is particularly important when the cutting wheels 5a, 5b are brought into contact with the workpiece 4.

Although not shown, drive transfer means is provided between the outer shaft 110b and the inner shaft 110a so that the motor 120, 121 can also drive the inner shaft 110a. This drive transfer arrangement needs to transfer the drive as the relative axial positions of the first and second shafts 110a and 110b are changed. One appropriate drive transfer means comprises a pin mounted on one of the shafts 110a, 110b and disposed in a recess in the other shaft 110a, 110b such that the rotating drive is transferred but axial movement is not opposed. In a preferred form the pin may be parallel to, but spaced from, the axis of rotation and arranged to run in an appropriate bore in the respective other shaft. If it is desired, a plurality of such pins might be provided. In another alternative, radial pins or splines might be used.

The outer shaft 10b is supported for rotation in a spaced pair of air bearings 102a and 102b provided in the main body 100. The main body 100 comprises internal drillings for supplying air to these air bearings 102a, 102b and exhausting spent air from the air bearings.

A seal bearing 103 is provided between the two supporting bearings 102a, 102b. This sealing bearing 103 is provided to seal, as effectively as is possible, an air passage 104 which runs from the main body 100 through the outer shaft 110b and into the centre of the inner shaft 110a. A seal bearing 103a is also provided on the inner shaft 110a about the point where the air passage 104 meets the inner shaft 110a. It will be appreciated that whilst an air passage 104 has been described, in actual fact there will be a plurality of drillings through both the outer shaft 110b and the inner shaft 110a to provide suitable paths for air as the two shafts are rotating.

The inner shaft 110a is a jetted shaft and internal drillings 114a leading to jets 115a to the external surface of this shaft 110a are provided to feed air to the gaps between the shafts 110a, 110b such that the inner shaft 110a runs on an air bearing within the outer shaft 110b.

The moving axial bearing assembly 130 is supported for axial movement in an air bearing 105 provided in the main body 100.

The axial bearing assembly 130 comprises inner drillings (not shown) for feeding air from the supporting air bearing 105 to the air bearings which support the disc like portion 113a of the inner shaft 110a.

Air is purged from the spindle under positive pressure at the region P where the inner and outer shafts 110a and 110b penetrate through the main body 100. This helps to ensure that external contaminants such as swarf or the by-products of sawing do not enter the spindle 1 where they would risk fouling the air bearings.

Carbon contact brushes 106a and 106b are provided in the axial bearing assembly 130 for contacting with the disc like portion 113a at the end of the inner shaft 110a. There is a complete electrical conduction path between the cutting wheels 5a, 5b and these brushes 106a, 106b via the metal of the shafts 110a and 110b. Thus, if leads from the carbon brushes 106a and 106b are connected to an appropriate detector (not shown), then provided that the cutting wheels 5a and 5b are conductive and an appropriate contact is made with a (conductive) workpiece 4 a circuit will be made as the cutting wheel 5a, 5b comes into contact with the workpiece. The detector can be used to sense the making of this circuit to determine that the blades 5a, 5b have touched down in contact with the workpiece 4.

It is envisaged that the machining spindle will be operated at cutting speeds in the order of 40,000 to 60,000 rpm and that the axial movement desired and provided by the axial bearing assembly 130 will be in the order of 6 to 7 mm. However, these figures only represent what might be true in respect of a typical machine and the present invention is in no way restricted to such values.

The axial drive means 131 or the axial bering assembly 130 is provided with an encoding scale to show the axial position of that component and hence the inner shaft 110a so that the spacing between the cutting wheels 5a, 5b can be accurately determined. In one particular application of the present spindle the facility for moving the shafts 110a, 10b relative to one another in an axial direction may be used to compensate for differential thermal growth in components of the spindle 1 during operation.

Typically, the shafts 110a, 110b will increase in length due to heating caused by high speed rotation. Whilst these changes of length and the differences in changes of length may be very small, they may still be important. The tolerances which must be met to properly dice semiconductor wafers, for example are very tight and this facility for thermal compensation can be particularly useful.

In a further application the cutting wheels 5a, 5b may be different from one another. For example, one of the wheels may be a V-cutter for scoring or making a first cut in the workpiece 4, whereas the second wheel may be chosen so as to be suitable for completing the cutting operation.

In an alternative rather than relying solely on positive air pressure purging to protect the spindle 1 against the ingress of foreign particles, a labyrinthine seal may be provided to give further protection.

FIG. 4 shows an alternative spindle 1′ which in many respects is similar to that shown in FIG. 3 and described above. Therefore, for the sake of brevity the same reference numerals are used for corresponding portions and a detailed description of these is omitted.

The main difference between the spindle shown in FIG. 4 and that shown in FIG. 3 is that an additional motor comprising a rotor 120a mounted on the inner shaft 110a and a corresponding stator 121a mounted in the main body 100 is provided in addition to a motor of the same type described above comprising a rotor 120 provided on the outer shaft 110b and a respective stator 121 mounted in the main body 100.

Thus, in the spindle 1′ shown in FIG. 4 there are two electric motors, one of which 120a, 121a is used to drive the inner shaft 10b and the other of which 120, 121 is used to drive the outer shaft 110b. Therefore, no drive transfer means is required between the inner and outer shafts 110a and 110b.

Moreover, the speed and direction of rotation of the shafts 110a, 110b and hence the cutting wheels 5a and 5b can be controlled independently from one another. Thus, in some instances, one of the cutting wheels 5a, 5b can be run at a different speed from the other or if it is desired, a first of the cutting wheels may be run in one direction and a second in the opposite direction.

One particular scenario where being able to run the blades in opposite directions may be of use, is where it is desired to perform cuts in both directions as the spindle traverses the workpiece. Similarly, being able to run the shafts at different speeds may be of assistance where the two cutting wheels 5a, 5b are different from one another and require different speeds of rotation for optimum performance.

Having said this, the spindle of FIG. 4 presents more production difficulties than that of FIG. 3 and hence such a spindle would be more expensive to produce and may suffer from performance degradation in some respects. As can be seen in FIG. 4, the inner shaft 110a in this spindle has greater length than that in the spindle shown in FIG. 3 and projects a significant distance beyond the region in which it is supported by the outer shaft 10b. Furthermore, significant mass in the form of the rotor 120a is mounted on the shaft at this extended portion. These factors will tend to make it harder to achieve smooth running with the spindle 1′ shown in FIG. 4 and may mean that the cutting rotational velocities, at least of the inner shaft 110a, must be reduced. Thus, for example, a rotational speed in the range of 28,000 to 40,000 rpm may be more manageable with the spindle 1′ of FIG. 4.

It will be noted that the shape and dimensions of the motors 120, 121, 121a, 120a provided for the outer and inner shafts 110b and 110a are different from one another. In colloquial terms one can be termed as being short and fat whilst the other one is long and thin. These shapes have been chosen in an effort to ensure that the motors can deliver the same or a similar power for use in rotation whilst best occupying the space available and minimising any adverse effects on the spindle's performance.

FIG. 5 shows a further alternative spindle 1″ which is a development of the spindle shown in FIG. 3. The spindle shown in FIG. 5 is similar in most currently important respects to that shown in FIG. 3 and therefore, for the sake of brevity, detailed description of these elements is omitted and the same reference numerals are used to indicate the same parts as in FIGS. 3 and 4.

The spindle shown in FIG. 5 includes drive transfer means as does the spindle shown in FIG. 3, but in FIG. 4 the drive transfer means are shown. The drive transfer means comprise a diametrically opposed pair of drive pins 1001. Each drive pin has a stem portion 1001a which is located in a closely fitting recess 1002 provided in the inner shaft 110a and a head portion 1001b located in a slot like aperture 1003 in the outer shaft 110b. The slot like aperture 1003 is dimensioned so as to closely fit the head portion 1001b of the respective drive pin 1001 in the circumferential direction but to be considerably larger than the head portion 1001b in the axial direction. This means that drive can be transferred from the outer shaft to the inner shaft via the pins 1001 acting as a drive transfer means but relative axial movement between the two shafts 110a and 110b is not impeded, because during this axial movement, the head portions 1001a can slide within the slot like apertures 1003.

The drive pins in this embodiment are provided so as to be insulating, that is to say, so that there is no electrical conduction path from the inner shaft 110a to the outer shaft 110b via the drive pins 1001. In some cases this may be achieved by using insulating drive pins but in the present embodiment this is achieved by the head portions 1001a of the drive pins 1001 having ceramic (i.e. non-insulating) covers. The provision of insulating drive means is useful because it means that the spindle as a whole may be constructed so that during operation there is no electrical conduction path between the inner and outer shafts 110a, 110b. This in turn facilitates the detection of tool touchdown on to conducting or semi-conducting work pieces.

Furthermore, to help in the electrical detection of tool touchdown, in the present embodiment, insulating sleeves 1004 are provided on the internal surface of the collar 112b of the outer shaft which surrounds the extension portion 112a of the inner shaft. These insulating sleeves 1004 serve as guide bearings for supporting the extension portion 112a of the inner shaft 110a and at the same time help to maintain electrical isolation between the inner shaft 110a and the outer shaft 110b.

Further, in the present embodiment, the brushes used to contact with the shafts 110a and 110b in the touchdown detection method are different from those in the embodiment shown in FIG. 3. In the embodiment of FIG. 5, one brush contacts with the disc like portion 113a at the end of the inner shaft 110a and a further brush is arranged for controllable contact with a shoulder portion 1005 of the outer shaft 10b at a region where the collar 112b meets the remainder of the outer shaft 110b. The location of this second brush B is indicated in FIG. 6 which shows the relevant portion of the spindle shown in FIG. 5. The second brush B is mounted on a spring loaded carrier C which biasses the brush B away from the outer shaft 110b. The carrier C has an associated pressurised air port AP via which pressurised air is supplied to force the brush B against the shaft 110b when sensing is desired. As soon as sensing is complete the air supply is cut and the brush B retracts under action of the spring. This arrangement significantly reduces brush wear which is a particular problem for the brush B which is contacting with a shaft surface that has a very high tangential velocity. Typically the brush B will only be forced against the outer shaft 110b until touchdown is detected, after this contact is not required until another touchdown event (or possibly lift off) is to be monitored Electrical connections to the brush 106a for connection to the inner shaft 110a via the disc like portion 113a is provided by way of a brass screw S at the end of the axial driving means assembly and is shown in FIG. 5. A wire (not shown) leads along the port AP for connection to the brush B contacting with the outer shaft 110b. These electrical connections are fed into a detector which looks for a circuit to be made between the two shafts by virtue of the tools (5a, 5b as shown in FIGS. 1 and 2), carried by the respective shafts 110a, 110b, coming into contact with a conducting or semi-conducting workpiece. This circuit, it will be seen, includes in series, a first of the shafts, then the workpiece and then the other of the shafts. Breaking of this circuit as the tools lift off the workpiece could be similarly detected if desired.

Whilst the above description has been written in terms of the cutting or dicing of workpieces, and in particular semiconductor workpieces, it should again be noted that the spindles of the present application and invention are not restricted to such uses. Thus, for example a spindle which is similar to that shown in FIG. 3, FIG. 4 or FIG. 5 may be used in other types of machining operations, for example, other cutting operations or grinding operations. By way of example, in the case of grinding, the shafts 110a and 110b may be used to support axial grinders or radial grinders. Thus, for example, the shafts 110a, 110b may be used to support cup grinders for axial grinding of a surface. By the same token radial grinders of perhaps different diameter may be used in form grinding of complex shapes. As a further example, one of the shafts may be used to carry a grinder for use in grinding the internal surface of a bore whereas the other may be used to carry a grinder for grinding an external surface of the component including the bore.

1-23. (canceled)

24. A machining spindle comprising an inner shaft arranged for carrying a first tool for machining a workpiece and an outer shaft arranged for carrying a second tool for machining the workpiece, the shafts being mounted for rotation about a common axis and for axial movement relative to each other, and the machining spindle further comprising a main body within which the shafts are journalled, the inner shaft being mounted within the outer shaft which in turn is journalled by means of an air bearing within the main body and there being an air bearing provided to allow relative axial movement between the inner and outer shafts, wherein the spindle comprises a sensor for sensing when the tools carried by the two shafts contact with a conducting or semi-conducting workpiece, the sensor being arranged to sense a current flowing around a path including the workpiece and the two shafts, and the spindle further comprises a drive transfer member for transferring drive from one shaft to the other so that the first and second shafts rotate in synchrony with one another, the drive transfer member being insulated so that it does not offer an electrical conduction path between the two shafts.

25. A machining spindle according to claim 24 in which the main body comprises jets to provide air to the air bearing allowing relative rotation between the main body and the outer shaft.

26. A machining spindle according to claim 24 in which the inner shaft comprises jets to provide air to the air bearing allowing relative axial movement between the inner and outer shafts.

27. A machining spindle according to claim 24 in which the air bearings are arranged such that air is purged from the spindle at positive pressure, relative to the ambient pressure, at all locations which may be exposed to the by-products of machining operations.

28. A machining spindle according to claim 24 in which at least one supplementary seal is provided.

29. A machining spindle according to claim 24 in which the spindle comprises at least one electric motor for rotatingly driving the shafts.

30. A machining spindle according to claim 24 in which the drive transfer member comprises a pin mounted on one of the shafts and disposed in a recess or an aperture in the other of the shafts such that shafts may move axially relative to one another without interrupting the transfer of drive.

31. A machining spindle according to claim 30 in which the pin is radially mounted.

32. A machining spindle according to claim 31 in which the pin is formed with at least one of an insulating material and an insulating material coating.

33. A machining spindle according to claim 24 in which the spindle comprises an axial drive arrangement for axially driving the shafts relative to one another.

34. A machining spindle according to claim 24 in which an encoding scale is provided to indicate the axial position of at least one of the shafts, which shaft is movable axially relative to the main body.

35. A machining spindle according to claim 24 in which the sensor comprises at least one brush contacting with one of the two shafts.

36. A machining spindle according to claim 24 in which the inner shaft is supported by insulating guide bearings.

37. A machining spindle according to claim 24, said spindle being a dicing spindle for use in dicing semi-conductor wafers, and the shafts each being arranged for supporting a respective cutting wheel.

38. A machining spindle according to claim 24, said spindle being a grinding spindle arranged for supporting grinding tools.

39. A machining apparatus comprising a machining spindle according to claim 24 and a support arrangement for supporting the spindle.

40. A machining apparatus according to claim 39 and further comprising a workpiece table arranged for supporting a workpiece during machining.

41. A method of machining a workpiece comprising the step of using a machining spindle as claimed in claim 24.

42. A method according to claim 41 comprising the step of using the ability to move one shaft axially relative to the other to compensate for one of thermal growth and differences of thermal growth, in at least one component of the spindle as it heats up due to operation.

43. A method of dicing semi-conductor wafers using a machining apparatus comprising a workpiece table for supporting a wafer and a machining spindle comprising an inner shaft carrying a first cutting wheel for machining the wafer, and an outer shaft carrying a second cutting wheel for machining the wafer, wherein the shafts are mounted for rotation about a common axis and for axial movement relative to each other, and the machining spindle comprises a main body within which the shafts are journalled, the inner shaft being mounted within the outer shaft which in turn is journalled by means of an air bearing within the main body, the method comprising the steps of:
cutting along streets in one direction on the wafer, having a first street spacing, using the two cutting wheels set at a first wheel spacing;
moving the shafts supporting the two cutting wheels axially relative to one another to set the cutting wheels at a second wheel spacing; and
cutting along streets in another direction on the wafer, having a second street spacing, using the two cutting wheels set at the second wheel spacing.

44. A machining spindle comprising an inner shaft arranged for carrying a first tool for machining a workpiece and an outer shaft arranged for carrying a second tool for machining the workpiece, the shafts being mounted for rotation about a common axis and for axial movement relative to each other, and the machining spindle further comprising a main body within which the shafts are journalled, the inner shaft being mounted within the outer shaft which in turn is journalled by means of an air bearing within the main body and there being an air bearing provided to allow relative axial movement between the inner and outer shafts, wherein the spindle comprises sensor means for sensing when the tools carried by the two shafts contact with a conducting or semi-conducting workpiece, the sensor means being arranged to sense a current flowing around a path including the workpiece and the two shafts, and the spindle further comprises drive transfer means for transferring drive from one shaft to the other, the drive transfer means being insulated so that it does not offer an electrical conduction path between the two shafts.

45. A machining spindle comprising an inner shaft arranged for carrying a first tool for machining a workpiece and an outer shaft arranged for carrying a second tool for machining the workpiece, the shafts being mounted for rotation about a common axis and for axial movement relative to each other, and the machining spindle further comprising a main body within which the shafts are journalled, the inner shaft being mounted within the outer shaft which in turn is journalled by means of an air bearing within the main body and there being an air bearing provided to allow relative axial movement between the inner and outer shafts, wherein the spindle comprises sensor means for sensing when the tools carried by the two shafts contact with a conducting or semi-conducting workpiece, the sensor means being arranged to sense a current flowing around a path including the workpiece and the two shafts, and the spindle further comprises drive transfer means for transferring drive from one shaft to the other so that the first and second shafts rotate in synchrony with one another, the drive transfer means being insulated so that it does not offer an electrical conduction path between the two shafts.
